(19) United States
(12) Patent Application Publication
(10) Pub. No.: US 2022/0411238 A1
(43) Pub. Date: Dec. 29, 2022

(54) CRANE HOOK POSITIONING METHOD, APPARATUS AND SYSTEM, AND ENGINEERING MACHINERY

(71) Applicant: ZOOMLION HEAVY INDUSTRY SCIENCE AND TECHNOLOGY CO., LTD., Changsha (CN)

(72) Inventors: Ling Fu, Changsha (CN); Qing Fan, Changsha (CN); Baike Xu, Changsha (CN); Yang Zeng, Changsha (CN)

(73) Assignee: ZOOMLION HEAVY INDUSTRY SCIENCE AND TECHNOLOGY CO., LTD., Changsha (CN)

(21) Appl. No.: 17/778,296

(22) PCT Filed: Jul. 10, 2020
(86) PCT No.: PCT/CN2020/101260

§ 371 Date: May 19, 2022

(30) Foreign Application Priority Data
Nov. 19, 2019 (CN) 201911136311.X

(51) Int. Cl. B66C 13/48; B66C 13/46; B66C 13/16

(52) U.S. Cl. CPC B66C 13/48; B66C 13/46; B66C 13/16

(57) ABSTRACT

A crane hook positioning method, apparatus and system, and piece of engineering machinery. The method comprises: acquiring current state information and a first image of a crane; determining a hoisting path according to the current state information and the relative position of a hook and a target to be positioned, wherein the relative position is determined according to the first image; and controlling the crane to execute hook positioning according to the hoisting path. An image of directly beneath a lifting arm is collected in real time, and a target is extracted by image processing to obtain three-dimensional coordinates of a hook, a hoisted object and a target in-position point, to determine the positional relationship between the hook, the hoisted object and the target in-position point; and hoisting path planning and hoisting work are realized according to current state information of a crane.

### FIELD OF THE INVENTION

The present disclosure relates to the technical field of crane automatic control, in particular to a crane hook positioning method, a crane hook positioning apparatus, a crane hook positioning system, and engineering machinery.

### BACKGROUND OF THE INVENTION

As a kind of hoisting and handling device, cranes are widely used in the construction industry, manufacturing industry and port transportation industry. During the traditional hoisting operation, the alignment of an empty hook and a hoisted object and the in-position of the hoisted object both require a hoisting commander to command an operator to complete the positioning operation of the hook or the hoisted object according to the position of the hook. This process is complex and tedious, and requires manual judgment and manual control. In addition, some hoisting operations are dangerous, and the commander cannot approach the designated position of the hoisted object, so it is impossible to give precise command to the operator. For large-scale hoisting, the hoisting process is becoming more and more complex, and the requirements for the operator and the hoisting commander are getting higher and higher, so the labor cost is high (each large-scale hoisting requires one operator and several hoisting commanders). Moreover, the operator's field of vision in the cab is limited, and it is not easy to see the hoisted object and the in-position point, let alone accurately judge the hoisting point and in-position point of the hoisted object, which may lead to misoperation, and the operation process is time-consuming.

### SUMMARY OF THE INVENTION

Implementations of the present disclosure aim to provide a crane hook positioning method, a crane hook positioning apparatus, a crane hook positioning system, and engineering machinery, for solving the problems that in an existing hoisting process, it is not easy for an operator to see a hoisted object and an in-position point, let alone accurately judge a hoisting point and the in-position point of the hoisted object, which may lead to misoperation, and the operation process is long.

In order to realize the above object, in a first aspect of the present disclosure, a crane hook positioning method is provided, including:

obtaining current state information and a first image of a crane, the first image including a hook of the crane and a target to be positioned;

determining relative position of the hook and the target to be positioned according to the first image, judging whether the relative position of the hook and the target to be positioned meets requirement, if so, completing hook positioning, otherwise, determining a hoisting path according to the current state information and the relative position of the hook and the target to be positioned; and

controlling the crane to execute hook positioning according to the hoisting path, the target to be positioned including a hoisted object or a target in-position point.

Optionally, the first image is collected by a camera disposed on a lifting arm of the crane, and the method further includes:

obtaining angle information of the camera, and controlling the camera according to the angle information to enable an optical axis of the camera to be perpendicular to the ground.

Optionally, before the determining the relative position of the hook and the target to be positioned according to the first image, the method further includes:

receiving a first instruction, selecting an identification area of the target to be positioned from the first image according to the first instruction, and performing contour extraction on an image of the target to be positioned in the identification area of the target to be positioned.

Optionally, the method further includes:

controlling the crane to stop hook positioning when an obstacle detection signal is received during hook positioning.

Optionally, the determining the relative position of the hook and the target to be positioned according to the first image includes:

establishing a plane coordinate system based on the first image;

extracting a contour of the hook and a contour of the target to be positioned based on the first image, obtaining coordinates of a center point of the contour of the hook and a center point of the contour of the target to be positioned on the plane coordinate system, and converting the coordinates into actual coordinates;

obtaining a distance between the camera and the target to be positioned according to a monocular ranging method;

obtaining a position of the hook and a height-above-ground of the camera, and obtaining a three-dimensional coordinate of the hook according to the position of the hook, the height-above-ground of the camera and the actual coordinate of the center point of the contour of the hook;

obtaining a three-dimensional coordinate of the target to be positioned according to the distance between the camera and the target to be positioned, the height-above-ground of the camera, and the actual coordinate of the center point of the contour of the target to be positioned; and

determining the relative position of the hook and the target to be positioned according to the three-dimensional coordinate of the hook and the three-dimensional coordinate of the target to be positioned.

Optionally, the determining the relative position of the hook and the target to be positioned according to the three-dimensional coordinate of the hook and the three-dimensional coordinate of the target to be positioned includes:

using a position of the hoisted object as the position of the hook when the contour of the target to be positioned is a contour of the target in-position point, extracting a contour of a reference object if a contour of the hoisted object is extracted from the first image, and an offset between the contour of the hoisted object and the contour of the target in-position point is less than a set threshold, and determining relative position of the hook and the target in-position point according to the contour of the reference object, the contour of the target in-position point and the contour of the hoisted object.

In a second aspect of the present disclosure, a crane hook positioning apparatus is provided, including:

a data collection unit, configured to obtain current state information and a first image of a crane, the first image including a hook of the crane and a target to be positioned;

a hoisting path determining unit, configured to determine relative position of the hook and the target to be positioned according to the first image, judge whether the relative position of the hook and the target to be positioned meets requirement, if so, complete hook positioning, otherwise, determine a hoisting path according to the current state information and the relative position of the hook and the target to be positioned; and

a hook positioning execution unit, configured to control the crane to execute hook positioning according to the hoisting path, the target to be positioned including a hoisted object or a target in-position point.

Optionally, the first image is collected by a camera disposed on a lifting arm of the crane, and the apparatus further includes:

a camera control unit, configured to obtain angle information of the camera, and control the camera according to the angle information to enable an optical axis of the camera to be perpendicular to the ground.

Optionally, the hoisting path determining unit is further configured to:

receive a first instruction, select an identification area of the target to be positioned from the first image according to the first instruction, and perform contour extraction on an image of the target to be positioned in the identification area of the target to be positioned.

Optionally, the hook positioning execution unit is further configured to:

control the crane to stop hook positioning when an obstacle detection signal is received during hook positioning.

Optionally, the hoisting path determining unit is further configured to:

establish a plane coordinate system based on the first image;

extract a contour of the hook and a contour of the target to be positioned based on the first image, obtain coordinates of a center point of the contour of the hook and a center point of the contour of the target to be positioned on the plane coordinate system, and convert the coordinates into actual coordinates;

obtain a distance between the camera and the target to be positioned according to a monocular ranging method;

obtain a position of the hook and a height-above-ground of the camera, and obtain a three-dimensional coordinate of the hook according to the position of the hook, the height-above-ground of the camera and the actual coordinate of the center point of the contour of the hook;

obtain a three-dimensional coordinate of the target to be positioned according to the distance between the camera and the target to be positioned, the height-above-ground of the camera, and the actual coordinate of the center point of the contour of the target to be positioned; and

determine the relative position of the hook and the target to be positioned according to the three-dimensional coordinate of the hook and the three-dimensional coordinate of the target to be positioned.

Optionally, the hoisting path determining unit is further configured to:

use a position of the hoisted object as the position of the hook when the contour of the target to be positioned is a contour of the target in-position point, extract a contour of a reference object if a contour of the hoisted object is extracted from the first image, and an offset between the contour of the hoisted object and the contour of the target in-position point is less than a set threshold, and determine relative position of the hook and the target in-position point according to the contour of the reference object, the contour of the target in-position point and the contour of the hoisted object.

In a third aspect of the present disclosure, a crane hook positioning system is provided, including:

the above crane hook positioning apparatus; and

an initial state detection apparatus, configured to detect current state information of a crane.

In a fourth aspect of the present disclosure, engineering machinery is provided, including the above crane hook positioning system.

According to the above technical solution of the present disclosure, an image directly beneath the lifting arm is collected in real time, and a target is extracted by means of image processing to obtain three-dimensional coordinates of the hook, the hoisted object and the target in-position point, so as to determine the positional relationship between the hook, the hoisted object and the target in-position point based on the obtained three-dimensional coordinates, hoisting path planning is realized in combination with a current slewing angle, amplitude of luffing and hook position data of the crane, the crane is controlled to execute hook positioning according to the hoisting path until the hook reaches a designated position, such that the real-time tracking and automatic positioning of the hook and other targets in a camera collection region are realized, a positioning process does not require a manual operation, and the positioning accuracy is high.

Other features and advantages of the implementations of the present disclosure will be described in detail in the subsequent detailed description.

### BRIEF DESCRIPTION OF DRAWINGS

The accompanying drawings are used to provide further understanding of the implementations of the present disclosure and form part of the specification, together with the following specific implementations, to explain the implementations of the present disclosure, but do not constitute restrictions on the implementations of the present disclosure. In the accompanying drawings:

FIG. 1 is a flow diagram of a crane hook positioning method provided by an implementation of the present disclosure.

FIG. 2 is a schematic diagram of a positioning principle of a crane hook positioning method provided by an implementation of the present disclosure.

FIG. 3 is a block diagram of a crane hook positioning apparatus provided by an implementation of the present disclosure.

FIG. 4 is a schematic structural diagram of a crane hook positioning system provided by an implementation of the present disclosure.

FIG. 5 is a schematic control flow diagram of a crane hook positioning system provided by an implementation of the present disclosure.

### DETAILED DESCRIPTION OF THE IMPLEMENTATIONS

The specific implementations of the present disclosure will be described in detail below with reference to the accompanying drawings. It should be understood that the specific implementations described herein are only used to illustrate and explain the present disclosure, but not to limit the present disclosure.

In the implementations of the present disclosure, the terms “including”, “comprising” or any other variation thereof are intended to encompass a non-exclusive inclusion such that a process, method, article of manufacture or device including a series of elements includes not only those elements, but also includes other elements not expressly listed, or elements inherent to such a process, method, article of manufacture or apparatus. Without further limitation, an element qualified by the phrase “including a . . . ” does not preclude the presence of additional identical elements in the process, method, article of manufacture or device that includes the element.

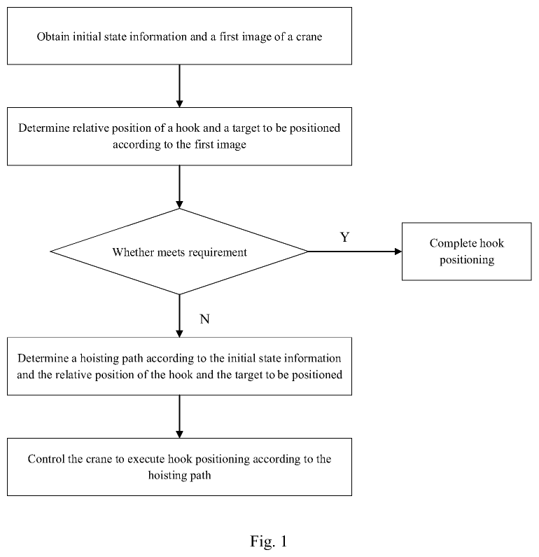

As shown in FIG. 1, in a first aspect of the present disclosure, a crane hook positioning method is provided, including:

current state information and a first image of a crane are obtained, the first image including a hook of the crane and a target to be positioned;

relative position of the hook and the target to be positioned are determined according to the first image, whether the relative position of the hook and the target to be positioned meets requirement is judged, if so, hook positioning is completed, otherwise, a hoisting path is determined according to current state information and the relative position of the hook and the target to be positioned; and

the crane is controlled to execute hook positioning according to the hoisting path, the target to be positioned including a hoisted object or a target in-position point.

The current state information includes a current slewing angle, amplitude of luffing and hook position of the crane. The hoisting path includes a slewing angle, amplitude of luffing and hook position to be executed by the crane.

In this way, in the implementation, the first image is collected in real time, and a target is extracted by means of image processing to obtain three-dimensional coordinates of the hook, the hoisted object and the target in-position point, so as to determine the positional relationship among the hook, the hoisted object and the target in-position point based on the obtained three-dimensional coordinates, hoisting path planning is realized in combination with the current slewing angle, amplitude of luffing and hook position data of the crane, the crane is controlled to execute hook positioning according to the hoisting path, and the above process is repeated until the hook reaches a designated position, such that the real-time tracking and automatic positioning of the hook and other targets in a camera collection region are realized, a positioning process does not require a manual operation, and the positioning accuracy is high.

When the crane is hoisting, the luffing, slewing and hoisting of the crane need to be coordinated and controlled in real time. By continuously adjusting the luffing, slewing and hoisting of the crane, the positioning of an empty hook or the hoisted object may be realized. The luffing refers to the amplitude of changing the crane, and the amplitude refers to the horizontal distance from the center line of the hook to the rotation center line of the crane. The slewing radius is also called the lifting radius or working radius of the crane. The hoisting action is used to control the length of a wire rope, so as to control the position of the hook. The positioning of the crane hook may be realized by luffing, slewing and hoisting actions.

Specifically, the implementation subject of the implementation may be implemented based on a processor or a control unit, and the processor or the control unit may be a part of the crane originally, or may be a new device, which is still under the protection scope of the implementation. The current state information in the implementation, that is, the current slewing angle, amplitude of lulling and hook position of the crane, may be obtained based on sensor detection. The first image is collected in real time by a camera disposed on a lifting arm of the crane. In order to make the first image easy to process and higher in processing accuracy, in the implementation, the camera is disposed at a top end of the lifting arm of the crane, and the camera is always perpendicular to the ground, such that the camera may always collect images of the hook and its surroundings. An operator controls the movement of the lifting arm of the crane according to the images collected by the camera, and stops moving the lifting arm until the images collected by the camera include the hook and the target to be positioned. When the target to be positioned is the hoisted object, it means that the crane may perform positioning of the hook to the position of the hoisted object, and when the target to be positioned is the target in-position point, it means that the crane may perform positioning of the hook to the position of the target in-position point.

Target extraction may be performed on the first image based on an image processing method to extract images of the hook and the target to be positioned, and plane coordinates of the hook and the target to be positioned on the first image are obtained. A pixel offset of the hook and the target to be positioned on the plane may be obtained based on the obtained coordinates, and an actual offset of the hook and the target to be positioned on the plane may be converted based on the obtained pixel offset. At the same time, the distance between the camera and the hook may be obtained based on the length of the hoisting wire rope, and the actual distance between the camera and the target to be positioned may be obtained through monocular ranging, so as to obtain the three-dimensional coordinates of the hook and the target to be positioned. Whether the relative position of the hook and the target to be positioned on the plane meets positioning requirement is judged by comparing the obtained actual offset with a preset offset threshold. For example, a threshold range may be set, and when the actual offset is within the set threshold range, it means that the hook and the target to be positioned coincide on the horizontal plane, and it is determined that the hook has reached the designated position on the horizontal plane. Similarly, whether the vertical distance between the hook and the target to be positioned meets the requirement may be judged based on the distance between the camera and the hook and the distance between the camera and the target to be positioned. If the distance between the hook and the target to be positioned in the horizontal plane and the vertical direction both meet the requirement, the positioning is completed. If not, the hoisting path of the crane may be determined according to the horizontal offset and the vertical distance difference between the hook and the target to be positioned, as well as the current slewing angle, amplitude of luffing and hook position of the crane. The hoisting path is the slewing angle, amplitude of luffing and hook position to be executed by the crane.

The crane is controlled to execute hook positioning according to the slewing angle, amplitude of luffing and hook position to be executed, such that the hook moves according to the determined hoisting path. The above process is repeated until the horizontal offset and vertical distance between the hook and the target to be positioned both meet the requirement, thereby completing hook positioning. The hoisting path may also be determined with a set step length each time, such that the hook gradually approaches the target to be positioned in the horizontal and vertical directions, thereby realizing hook positioning.

In the implementation, a position signal and frequency signal of a detection drum are detected by a hoisting detection apparatus installed on a hoisting drum, and sent to the processor or the control unit via a CAN bus to calculate the current length of the hoisting wire rope, such that the hook position of the crane, that is, the vertical distance between the hook and the camera, is determined. A slewing detection apparatus is disposed at the slewing center of the crane to detect the slewing angle of the crane and send the slewing angle to the processor or the control unit via the CAN bus. A luffing detection unit is disposed on the lifting arm of the crane to detect the luffing angle of the lifting arm of the crane, and send the luffing angle to the processor or the control unit via the CAN bus to calculate the amplitude and height of luffing of the crane according to the luffing angle. The hoisting detection apparatus may be, but not limited to, an encoder. The slewing detection apparatus and the luffing detection unit may be, but not limited to, an angle sensor.

In order to make the subsequent image processing have high accuracy, the camera needs to be always located over the ground. Therefore, in the implementation, the first image is collected by the camera disposed on the lifting arm of the crane, and the optical axis of the camera is made to be perpendicular to the ground by obtaining the angle information of the camera and controlling the camera according to the angle information. The angle information of the camera may be collected by an angle sensor disposed on the camera. The posture of the camera may be controlled by an electric pan-tilt carrying the camera. The processor or the control unit receives the angle information of the camera collected by the angle sensor, and controls the action of the electric pan-tilt according to the angle information to keep the optical axis of the camera perpendicular to the ground, so as to ensure that the first image collected by the camera is always an image directly beneath the camera. In order to make the hook position in the first image as close as possible to the image center to obtain more image information around the hook, in the implementation, the camera and the electric pan-tilt are disposed at the top end of the lifting arm of the crane, such that the camera is as close as possible to the wire rope of the hook.

In order to enable the crane operator to observe the conditions around the hook intuitively, before the relative position of the hook and the target to be positioned are determined according to the first image, the implementation further includes:

a first instruction is received, an identification area of the target to be positioned is selected from the first image according to the first instruction, and contour extraction is performed on an image of the target to be positioned in the identification area of the target to be positioned.

Specifically, the first instruction may be a gesture instruction sent by the operator via a touch panel. The operator observes images returned by the camera in real time via the touch panel, and selects the identification area of the target to be positioned by framing on the touch panel via the gesture instruction. The processor or the control unit receives the first instruction and performs contour extraction of the image of the target on the selected identification area of the target to be positioned in the first image. The image contour of the target to be positioned is extracted via edge detection, feature point extraction, and feature matching, and the extracted target image contour is highlighted via the touch panel. After the target to be positioned is determined, the operator sends a second instruction via the touch panel, such that the processor or the control unit executes automatic positioning of the hook according to the first image collected by the camera and the extracted target image contour. In addition, in each frame of image collected later, the image contour of the target to be positioned is always kept highlighted, so as to realize automatic tracking of the target.

Since the hoisting operation of the crane has certain risks, the method of the implementation further includes:

the crane is controlled to stop hook positioning when an obstacle detection signal is received during hook positioning.

Obstacles around the hook are detected by an obstacle detection apparatus disposed on the hook. The obstacle detection apparatus may be, but is not limited to, an ultrasonic sensor. An echo signal may be generated when there is an obstacle within the detection range of the ultrasonic sensor. The ultrasonic sensor sends the received echo signal to the processor or the control unit, and the processor or the control unit controls the lifting arm of the crane to stop movement, thereby ensuring the safety during hook positioning.

For most of current hook positioning methods, a positioning apparatus, such as a GPS positioner, an ultrasonic ranging sensor and a gyroscope, is installed on a hook for hook positioning. As being installed on the hook, the positioning apparatus is complex to transform the structure and prone to being damaged during construction. Some methods use GPS, GNSS and other mobile stations for position measurement, which is expensive and lacks flexibility. The hoisting range of the crane is large, the detection range is more than or equal to 50 meters, and there is currently no better method to realize target detection and positioning in a large space range. Therefore, in the implementation, a monocular camera is used for dynamic identification of a target to be measured, and relative position of the camera and the target to be measured are calculated in real time, so as to track the target, such that the target position is accurately positioned. The movement of the lifting arm is controlled in real time according to the deviation between the target position and the current lifting arm, and thus a tail end of a boom is automatically controlled to reach a position over the target to be measured via actions such as luffing, slewing and hoisting, so as to realize accurate positioning of hoisting and in-position of the hoisted object, thereby reducing the operation intensity of the operator.

Thus, in the implementation, determining the relative position of the hook and target to be positioned according to first image includes:

a plane coordinate system is established based on the first image;

a contour of the hook and a contour of the target to be positioned are extracted based on the first image, coordinates of a center point of the contour of the hook and a center point of the contour of the target to be positioned on the plane coordinate system are obtained, and the coordinates are converted into actual coordinates;

a distance between the camera and the target to be positioned is obtained according to a monocular ranging method;

a position of the hook and a height-above-ground of the camera are obtained, and a three-dimensional coordinate of the hook is obtained according to the position of the hook, the height-above-ground of the camera and the actual coordinate of the center point of the contour of the hook;

a three-dimensional coordinate of the target to be positioned is obtained according to the distance between the camera and the target to be positioned, the height-above-ground of the camera, and the actual coordinate of the center point of the contour of the target to be positioned; and

the relative position of the hook and the target to be positioned are determined according to the three-dimensional coordinate of the hook and the three-dimensional coordinate of the target to be positioned.

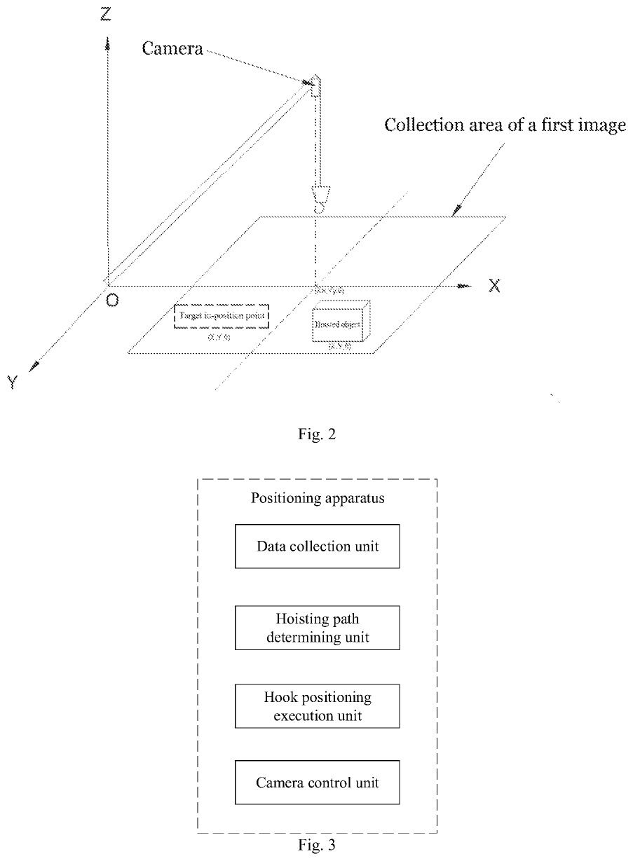

Specifically, FIG. 2 is a schematic diagram of a principle of the implementation, where (X, Y, Z) is a world coordinate system, and (x, y, z) is a plane coordinate system established based on the first image. The first image is preprocessed with a center point of the first image as an origin, and subjected to gray processing. The edge detection, feature point extraction and feature point matching are performed on a target image in an identification area of a target to be positioned selected via a first instruction, so as to extract contour information of the target image. First, an image edge of the target image is determined via an edge detection algorithm, and corner detection is performed on the target image inside the extracted image edge. First, according to the search sequence from left to right and bottom to top, a lower left boundary point of the edge of the target image is determined as a start point, and the upper left is defined as an initial search direction. If a point in this direction is a feature point, the point is judged as a boundary point; otherwise, the search direction is rotated by 45 degrees clockwise. The process is repeated until a first feature point is found, and the first feature point is taken as a new boundary point. The current search direction is rotated by 90 degrees counterclockwise to continue the search for the next feature point until an end point is found. Thus, the contour information of the target image is extracted. The end point is the start point of the edge of the target image determined above. The extracted target image is filtered and subjected to mathematical morphological processing such as dilation, erosion and closing operation, so as to eliminate noise and smooth image contour. According to the obtained target image contour, the smallest rectangle that may bound the target image is determined via a minimum bounding rectangle method, and a center point of the smallest rectangle is used as a center point of the target image. Since obtained coordinate of the center point of the target image is pixel coordinate, the obtained coordinate need to be converted to actual coordinate. Internal parameters and external parameters of the camera are obtained by calibrating the camera. In the implementation, the camera is calibrated via a checkerboard, and the image coordinates in pixels may be converted into actual coordinates in millimeters according to the obtained internal parameters and external parameters. Since the conversion between pixel coordinates and actual coordinates is an existing technology, the specific conversion process will not be described here.

At present, a ranging method commonly used by the monocular camera is a similar triangle method. According to a pinhole imaging model and the similar triangle method, the distance between the camera and a target object may be obtained as D=(W*F)/P, where F is a focal length, P is a pixel width of the target object, W is an actual width of the target object, and D is a distance from the camera to the target object. Taking the target object being the hoisted object as an example, the actual width W of the hoisted object, the pixel width P and the focal length F of the camera may all be directly obtained, and then an actual distance between the camera and the hoisted object may be derived according to D=(W*F)/P. The height-above-ground value of the top end of the lifting arm obtained by a moment limiter is received, and used as a height-above-ground value of the camera. A height-above-ground value of the hoisted object may be obtained according to the height-above-ground value of the camera and the actual distance between the camera and the hoisted object. A height-above-ground of the hook may be obtained according to the distance between the camera and the hook and the height-above-ground value of the camera.

The height-above-ground of the hook and the actual coordinate of the center point of the hook is obtained respectively through the above methods, such that three-dimensional coordinate of the hook in the world coordinate system may be obtained. Three-dimensional coordinate of the target to be positioned in the world coordinate system may be obtained similarly. The relative position of the hook and the target to be positioned may be determined according to the obtained the three-dimensional coordinate of the hook and the three-dimensional coordinate of the target to be positioned. The hoisting path of the crane may be determined in combination with the current slewing angle, amplitude of luffing and hook position of the crane. At the same time, when a difference value between the obtained height-above-ground of the hook and the height-above-ground of the hoisted object is within a set range, the lifting arm of the crane is controlled to stop movement, thereby ensuring the safety during the hoisting operation. For example, it may be set that when the hook reaches 2 meters over the target via slewing, luffing and hoisting of the lifting arm of the crane, early warning is performed, and when the hook reaches 1 meter over the target, an alarm is given and the hoisting action is stopped.

There are usually two cases in the actual hoisting operation of the crane. The first case is that positioning of the hook to the position of the hoisted object, that is, positioning of an empty hook, needs to be performed. The second case is that the hook lifts the hoisted object to the designated target in-position point. When the hoisting operation is the second case, the hoisted object may block the target in-position point during image processing, thus affecting the positioning accuracy of the hook. Therefore, determining the relative position of the hook and the target to be positioned according to the three-dimensional coordinate of the hook and the three-dimensional coordinate of the target to be positioned includes:

the position of the hoisted object is used as the position of the hook when the contour of the target to be positioned is a contour of the target in-position point, a contour of a reference object is extracted if a contour of the hoisted object is extracted from the first image, and an offset between the contour of the hoisted object and the contour of the target in-position point is less than a set threshold, and relative position of the hook and the target in-position point are determined according to the contour of the reference object, the contour of the target in-position point and the contour of the hoisted object.

Specifically, when the crane performs positioning of the empty hook, and the target to be positioned is the hoisted object, the contour of the target to be positioned extracted from the first image is the contour of the hoisted object, the three-dimensional coordinates of the hook and the hoisted object are determined by the above method, and then the relative position of the hook and the hoisted object may be determined, such that the empty hook may reach the designated position where the hoisted object may be hooked by controlling the slewing, luffing and hook position of the crane.

When the crane executes the carrying operation, that is, when the hoisted object is hoisted to the designated target in-position point via the hook, the target to be positioned is the target in-position point, and the contour of the target to be positioned extracted from the first image is the contour of the target in-position point. If the contour of the hoisted object is extracted from the first image, whether the offset between the center point of the contour of the hoisted object and the center point of the contour of the target in-position point is less than the preset threshold is judged according to the preset threshold. If so, it is judged that the hoisted object is about to block the target in-position point. At this time, a side, away from the contour of the hoisted object, of the contour of the target in-position point is searched for an area with dense feature points, and the contour of the reference object is extracted from the area as a reference target. The coordinate of the center point of the extracted contour of the reference object is obtained by the above method, and relative position of the reference object and the target in-position point may be obtained according to the coordinate of the center point of the contour of the reference object and the coordinate of the center point of the contour of the target in-position point. Thus, relative position of the hoisted object and the target in-position point are determined according to the positional relationship among the reference object, the target in-position point and the hoisted object, so as to realize positioning. In actual operation, it may be considered that when the hoisted object is hooked on the hook, the center point of the hook coincides with the center point of the hoisted object, such that the positioning of the center point of the hook is determined when the positioning of the center point of the hoisted object is determined. Judging whether the hoisted object is about to block the target in-position point based on the contour of the hoisted object and the contour of the target in-position point, and determining the relative position of the hoisted object and the target in-position point based on the relative positional relationship of the reference object and the target in-position point may also be realized by the extracted feature points on the edge of the image contour.

Based on the above method, feature point extraction and matching are performed on a target image in each frame of image obtained by the camera, and at the same time, the target image contour in the selected range is kept highlighted, thereby realizing dynamic tracking and identification of the target.

As shown in FIG. 3, in a second aspect of the present disclosure, a crane hook positioning apparatus is provided, including:

a data collection unit, configured to obtain current state information and a first image of a crane, the first image including a hook of the crane and a target to be positioned;

a hoisting path determining unit, configured to determine relative position of the hook and the target to be positioned according to the first image, judge whether the relative position of the hook and the target to be positioned meets requirement, if so, complete hook positioning, otherwise, determine a hoisting path according to the current state information and the relative position of the hook and the target to be positioned; and

a hook positioning execution unit, configured to control the crane to execute hook positioning according to the hoisting path, the target to be positioned including a hoisted object or a target in-position point.

Optionally, the first image is collected by a camera disposed on a lifting arm of the crane. The apparatus further includes:

a camera control unit, configured to obtain angle information of the camera, and control the camera according to the angle information to enable an optical axis of the camera to be perpendicular to the ground.

Optionally, the hoisting path determining unit is further configured to:

receive a first instruction, select an identification area of the target to be positioned from the first image according to the first instruction, and perform contour extraction on an image of the target to be positioned in the identification area of the target to be positioned.

Optionally, the hook positioning execution unit is further configured to:

control the crane to stop hook positioning when an obstacle detection signal is received during hook positioning.

Optionally, the hoisting path determining unit is further configured to:

establish a plane coordinate system based on the first image;

extract a contour of the hook and a contour of the target to be positioned based on the first image, obtain coordinates of a center point of the contour of the hook and a center point of the contour of the target to be positioned on the plane coordinate system, and convert the coordinates into actual coordinates;

obtain a distance between the camera and the target to be positioned according to a monocular ranging method;

obtain a position of the hook and a height-above-ground of the camera, and obtain a three-dimensional coordinate of the hook according to the position of the hook, the height-above-ground of the camera and the actual coordinate of the center point of the contour of the hook; obtain a three-dimensional coordinate of the target to be positioned according to the distance between the camera and the target to be positioned, the height-above-ground of the camera, and the actual coordinate of the center point of the contour of the target to be positioned; and

determine the relative position of the hook and the target to be positioned according to the three-dimensional coordinate of the hook and the three-dimensional coordinate of the target to be positioned.

Optionally, the hoisting path determining unit is further configured to:

use a position of the hoisted object as the position of the hook when the contour of the target to be positioned is a contour of the target in-position point, extract a contour of a reference object if a contour of the hoisted object is extracted from the first image, and an offset between the contour of the hoisted object and the contour of the target in-position point is less than a set threshold, and determine relative position of the hook and the target in-position point according to the contour of the reference object, the contour of the target in-position point and the contour of the hoisted object.

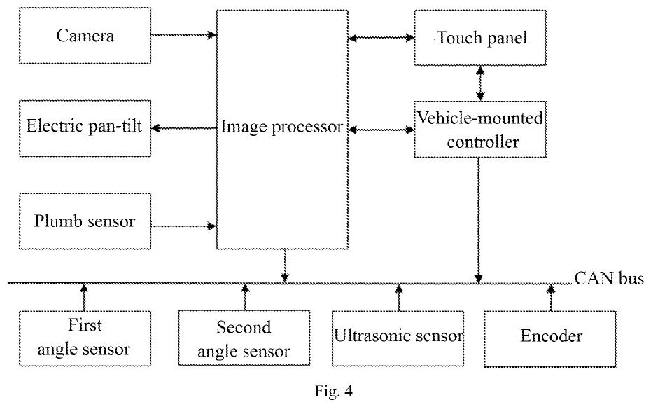

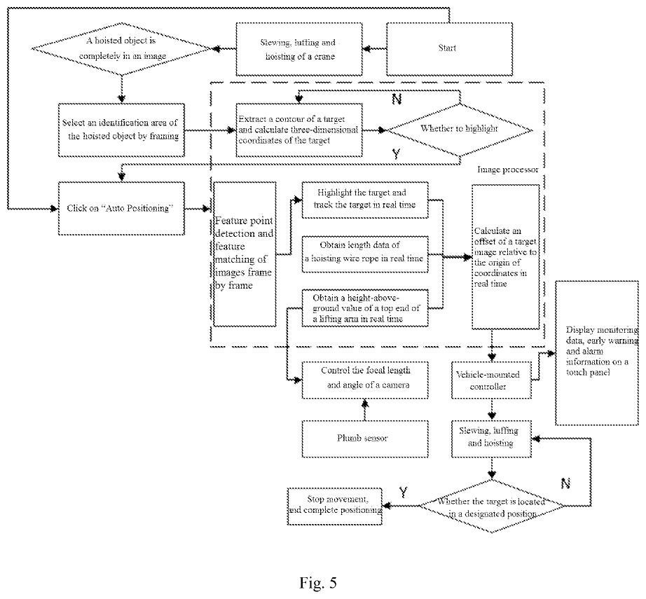

As shown in FIG. 4 and FIG. 5, in a third aspect of the present disclosure, a crane hook positioning system is provided, including:

the above crane hook positioning apparatus; and

an initial state detection apparatus, configured to detect current state information of a crane. In the implementation, the current state information of the crane includes a current slewing angle, amplitude of luffing and hook position of the crane.

In the implementation, the implementation subject of the data collection unit, the hoisting path determining unit and the camera control unit in the above crane hook positioning apparatus is an image processor, and the data collection unit and the hoisting path determining unit may be program modules integrated on the image processor. The implementation subject of the hook positioning execution unit is a vehicle-mounted controller on the crane. The vehicle-mounted controller controls a corresponding solenoid valve group according to the determined hoisting path, so as to control the lifting arm of the crane to perform slewing, luffing and taking-up and paying-off of the wire rope of the hook according to the hoisting path.

In the implementation, a camera is fixedly installed on an electric pan-tilt, and the electric pan-tilt is disposed at a top end of the lifting arm. An angle detection apparatus adopts a plumb sensor, and the plumb sensor is disposed on the camera for detecting posture information of the camera. An output end of the plumb sensor is connected to the image processor. At the same time, the image processor is also connected to the electric pan-tilt and the camera respectively. The image processor may control the electric pan-tilt to adjust the posture according to the received posture information of the camera, such that the optical axis of the camera is always kept perpendicular to the ground. The image processor may also obtain a height-above-ground value of the top end of the lifting arm from the vehicle-mounted controller via a CAN bus, so as to control the focus of the camera to be adjusted. The height-above-ground value of the top end of the lifting arm is obtained by the vehicle-mounted controller from a moment limiter of the crane. The moment limiter may calculate the height-above-ground value of the top end of the lifting arm in real time based on a current length and angle of a boom of the lifting arm.

The initial state detection apparatus includes a first angle sensor disposed on the slewing center of the crane and configured to collect the slewing angle of the crane, a second angle sensor disposed on the lifting arm of the crane and configured to collect the luffing angle of the lifting arm of the crane, and an encoder installed on a hoisting drum via a coupling so as to rotate concentrically with the hoisting drum to collect a position signal and frequency signal of the drum.

In the implementation, the system further includes an obstacle detection apparatus and a display apparatus. The obstacle detection apparatus adopts an ultrasonic sensor, and there may be a plurality of ultrasonic sensors. The ultrasonic sensor is installed on the hook to detect whether there are obstacles around the hook in the scope of action of ultrasonic sensor. The display apparatus may be, but not limited to, a touch panel. The camera is connected to the touch panel by wire or wirelessly. The touch panel is connected to the image processor and the vehicle-mounted controller respectively for realizing human-computer interaction, displaying images collected by the camera, the current slewing angle, amplitude of luffing and hook position of the crane returned by the vehicle-mounted controller, and other parameters in real time, and highlighting the contour of the target to be positioned.

The ultrasonic sensor, the first angle sensor, the second angle sensor and the encoder are all in communication connection with the vehicle-mounted controller and the image processor via a CAN bus. The touch panel is disposed in a cab of the crane so that an operator may observe the situation around the hook in real time for easy operation. When the system starts, the operator observes the situation around the hook via the touch panel and controls the movement of the lifting arm of the crane, and stops controlling the movement of the lifting arm of the crane until a hoisted object appears on the touch panel. The operator selects an identification area of the hoisted object by framing on the touch panel. For example, the selected area may be a circle with the target as the center and X times the diameter of a target frame as the radius, where the multiple may be determined according to actual situations. For example, when the hoisted object may block a target in-position point, a larger multiple may be set, such that there are other references in the selected area, and an actual position of the hook is calculated according to the relative positional relationship of other references. When the selected area is determined, the image processor extracts the contour of the target and highlights the contour of the target on the touch panel, and the operator clicks an “Auto Positioning” button. The image processor obtains the slewing angle, amplitude of lulling and hook position data of the lifting arm of the crane via a CAN bus to generate a hoisting path. The vehicle-mounted controller controls the lifting arm of the crane to perform the hoisting operation according to the hoisting path, so as to realize automatic positioning. When the hook reaches a warning distance from the target in-position point, warning and alarm information is displayed on the touch panel.

In a fourth aspect of the present disclosure, engineering machinery is provided, including the above crane hook positioning system.

The present application is described with reference to the flow diagram and/or block diagram of the methods, apparatuses (systems), and computer program products according to the embodiments of the present application. It should be understood that each flow and/or block in the flow diagram and/or block diagram and the combination of flows and/or blocks in the flow diagram and/or block diagram may be implemented by computer program instructions. These computer program instructions may be provided to processors of a general-purpose computer, a special-purpose computer, an embedded processor or other programmable data processing devices to generate a machine, so that instructions executed by processors of a computer or other programmable data processing devices generate an apparatus for implementing the functions specified in one or more flows of the flow diagram and/or one or more blocks of the block diagram.

These computer program instructions may also be stored in a computer-readable memory capable of guiding a computer or other programmable data processing devices to work in a specific manner, so that instructions stored in the computer-readable memory generate a manufacturing product including an instruction apparatus, and the instruction apparatus implements the functions specified in one or more flows of the flow diagram and/or one or more blocks of the block diagram.

These computer program instructions may also be loaded on a computer or other programmable data processing devices, so that a series of operation steps are executed on the computer or other programmable devices to produce computer-implemented processing, and thus, the instructions executed on the computer or other programmable devices provide steps for implementing the functions specified in one or more flows of the flow diagram and/or one or more blocks of the block diagram.

The preferred implementations of the present disclosure are described in detail above in combination with the accompanying drawings. However, the implementations of the present disclosure are not limited to the specific details of the above implementations. Within the scope of the technical concept of the implementations of the present disclosure, a variety of simple modifications may be made to the technical solutions of the implementations of the present disclosure, and these simple modifications belong to the protection scope of the implementations of the present disclosure.

In addition, it should be noted that the specific technical features described in the above detailed description may be combined in any suitable way without contradiction. In order to avoid unnecessary repetition, various possible combination methods will not be described separately in the implementations of the present disclosure.

Those skilled in the art can understand that all or part of the steps in the method for implementing the above implementations may be completed by instructing relevant hardware through a program. The program is stored in a storage medium, and includes several instructions used to enable a single-chip microcomputer, a chip or a processor to execute all or part of the steps of the method described in the implementations of the present disclosure. The above storage medium includes a USB flash disk, a mobile hard disk, a read-only memory (ROM), a random access memory (RAM), a disk, a compact disc or other media capable of storing program codes.

1. A crane hook positioning method, comprising:
obtaining current state information and a first image of a crane, the first image comprising a hook of the crane and a target to be positioned;
determining relative position of the hook and the target to be positioned according to the first image, judging whether the relative position of the hook and the target to be positioned meets requirement, if so, completing hook positioning, otherwise, determining a hoisting path according to the current state information and the relative position of the hook and the target to be positioned; and
controlling the crane to execute hook positioning according to the hoisting path, the target to be positioned comprising a hoisted object or a target in-position point.

2. The crane hook positioning method according to claim 1, wherein the first image is collected by a camera disposed on a lifting arm of the crane, and the method further comprises:
obtaining angle information of the camera, and controlling the camera according to the angle information to enable an optical axis of the camera to be perpendicular to the ground.

3. The crane hook positioning method according to claim 1, wherein before the determining the relative position of the hook and the target to be positioned according to the first image, the method further comprises:
receiving a first instruction, selecting an identification area of the target to be positioned from the first image according to the first instruction, and performing contour extraction on an image of the target to be positioned in the identification area of the target to be positioned.

4. The crane hook positioning method according to claim 1, further comprising:
controlling the crane to stop hook positioning when an obstacle detection signal is received during hook positioning.

5. The crane hook positioning method according to claim 2, wherein the determining the relative position of the hook and the target to be positioned according to the first image comprises:
establishing a plane coordinate system based on the first image;
extracting a contour of the hook and a contour of the target to be positioned based on the first image, obtaining coordinates of a center point of the contour of the hook and a center point of the contour of the target to be positioned on the plane coordinate system, and converting the coordinates into actual coordinates;
obtaining a distance between the camera and the target to be positioned according to a monocular ranging method;
obtaining a position of the hook and a height-above-ground of the camera, and obtaining a three-dimensional coordinate of the hook according to the position of the hook, the height-above-ground of the camera and the actual coordinate of the center point of the contour of the hook;
obtaining three-dimensional coordinate of the target to be positioned according to the distance between the camera and the target to be positioned, the height-above-ground of the camera, and the actual coordinate of the center point of the contour of the target to be positioned; and
determining the relative position of the hook and the target to be positioned according to the three-dimensional coordinate of the hook and the three-dimensional coordinate of the target to be positioned.

6. The crane hook positioning method according to claim 5, wherein the determining the relative position of the hook and the target to be positioned according to the three-dimensional coordinate of the hook and the three-dimensional coordinate of the target to be positioned comprises:
using a position of the hoisted object as the position of the hook when the contour of the target to be positioned is a contour of the target in-position point, extracting a contour of a reference object if a contour of the hoisted object is extracted from the first image, and an offset between the contour of the hoisted object and the contour of the target in-position point is less than a set threshold, and determining relative position of the hook and the target in-position point according to the contour of the reference object, the contour of the target in-position point and the contour of the hoisted object.

7. A crane hook positioning apparatus, comprising:
a data collection unit, configured to obtain current state information and a first image of a crane, the first image comprising a hook of the crane and a target to be positioned;
a hoisting path determining unit, configured to determine relative position of the hook and the target to be positioned according to the first image, judge whether the relative position of the hook and the target to be positioned meets requirement, if so, complete hook positioning, otherwise, determine a hoisting path according to the current state information and the relative position of the hook and the target to be positioned; and
a hook positioning execution unit, configured to control the crane to execute hook positioning according to the hoisting path, the target to be positioned comprising a hoisted object or a target in-position point.

8. The crane hook positioning apparatus according to claim 7, wherein the first image is collected by a camera disposed on a lifting arm of the crane, and the apparatus further comprises:
a camera control unit, configured to obtain angle information of the camera, and control the camera according to the angle information to enable an optical axis of the camera to be perpendicular to the ground.

9. The crane hook positioning apparatus according to claim 7, wherein the hoisting path determining unit is further configured to:
receive a first instruction, select an identification area of the target to be positioned from the first image according to the first instruction, and perform contour extraction on an image of the target to be positioned in the identification area of the target to be positioned.

10. The crane hook positioning apparatus according to claim 7, wherein the hook positioning execution unit is further configured to:
control the crane to stop hook positioning when an obstacle detection signal is received during hook positioning.

11. The crane hook positioning apparatus according to claim 8, wherein the hoisting path determining unit is further configured to:
establish a plane coordinate system based on the first image;
extract a contour of the hook and a contour of the target to be positioned based on the first image, obtain coordinates of a center point of the contour of the hook and a center point of the contour of the target to be positioned on the plane coordinate system, and convert the coordinates into actual coordinates;
obtain a distance between the camera and the target to be positioned according to a monocular ranging method;
obtain a position of the hook and a height-above-ground of the camera, and obtain a three-dimensional coordinate of the hook according to the position of the hook, the height-above-ground of the camera and the actual coordinate of the center point of the contour of the hook;
obtain a three-dimensional coordinate of the target to be positioned according to the distance between the camera and the target to be positioned, the height-above-ground of the camera, and the actual coordinate of the center point of the contour of the target to be positioned; and
determine the relative position of the hook and the target to be positioned according to the the three-dimensional coordinate of the hook and the three-dimensional coordinate of the target to be positioned.

12. The crane hook positioning apparatus according to claim 11, wherein the hoisting path determining unit is further configured to:
use a position of the hoisted object as the position of the hook when the contour of the target to be positioned is a contour of the target in-position point, extract a contour of a reference object if a contour of the hoisted object is extracted from the first image, and an offset between the contour of the hoisted object and the contour of the target in-position point is less than a set threshold, and determine relative position of the hook and the target in-position point according to the contour of the reference object, the contour of the target in-position point and the contour of the hoisted object.

13. A crane hook positioning system, comprising:
the crane hook positioning apparatus according to claim 7;
an image collection apparatus, configured to collect a first image; and
an initial state detection apparatus, configured to detect current state information of a crane.

14. Engineering machinery, comprising the crane hook positioning system according to claim 13.
